(19) United States
(12) Patent Application Publication
(10) Pub. No.: US 2007/0072029 A1
(43) Pub. Date: Mar. 29, 2007

(54) FLOW RATE ADJUSTING SYSTEM AND FUEL CELL SYSTEM

(76) Inventors: Kei MASUNISHI, Kawasaki-shi (JP); Hideo Iwasaki, Kawasaki-shi (JP); Yoshiyuki Isozaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/531,172

(22) Filed: Sep. 12, 2006

(30) Foreign Application Priority Data
Sep. 29, 2005 (JP) 2005-283362

(51) Int. Cl. H01M 8/04; H01M 8/06; F17D 1/00; F16K 49/00

(52) U.S. Cl. 429/26; 429/19; 429/34; 429/25; 429/24; 429/22; 137/2; 137/334

(57) ABSTRACT

A fuel supplied to a fuel cell is allowed to flow into an orifice channel in an orifice chip having a temperature control module such as a ceramic heater or a Peltier element. The temperature control module controls the temperature of the orifice channel to regulate the flow rate of a fuel passing through the orifice channel.

### CROSS-REFERENCE TO RELATED APPLICATIONS

This application is based upon and claims the benefit of priority from prior Japanese Patent Application No. 2005-283362, filed Sep. 29, 2005, the entire contents of which are incorporated herein by reference.

### BACKGROUND OF THE INVENTION

1. Field of the Invention

The present invention relates to a flow rate adjusting system and a fuel cell system which can adjust the flow rate of a fuel supplied to a fuel cell, a fuel reformer, or the like.

2. Description of the Related Art

In recent years, the sizes of electronic instruments such as personal computers and cellular phones have been markedly reduced. With this reduction in size, attempts have been made to use fuel cells as a power source. Fuel cells have the advantages of being able to generate power using a fuel and an oxidizer supplied and of being able to continuously generate power with only the fuel refilled. Accordingly, the fuel cell is very effective as a power source for small-sized electronic instruments.

Proposed fuel cells include a direct methanol fuel cell that generates power using methanol supplied directly to an anode and a reformed fuel cell that generates power using a hydrogen gas into which an organic fuel is reformed by a reformer.

To stably operate the fuel cell or fuel reformer, it is very important for the operation of a fuel cell system to stably maintain the fixed flow rate of the fuel supplied to the fuel cell or reformer and to appropriately adjust the flow rate.

For example, Jpn. Pat. Appln. KOKAI No. 2002-349722 discloses a technique for adjusting the flow rate of a fluid to a fuel cell or the like. The flow rate adjusting apparatus disclosed in this publication has a valve portion provided at the tip of a shaft and which can be inserted into a valve hole, and a valve seat provided on the shaft to block the periphery of the valve hole. This apparatus adjusts the flow rate as follows. The valve portion is moved from its closed position by a predetermined amount with respect to the valve hole to allow the valve seat to unblock the valve hole. A small amount of gas thus flows through a hole of the valve portion.

Jpn. Pat. Appln. KOKAI No. 2000-163134 discloses an apparatus which senses the temperature or pressure of a fluid, the opening of a valve, or the like and which calculates the mass flow rate of the fluid on the basis of the sensor output. The apparatus adjusts the opening of the valve so as to set the calculated mass flow rate to a predetermined amount and repeats similar calculations.

Both apparatuses disclosed in Jpn. Pat. Appln. KOKAI No. 2002-349722 and 2000-163134 use an electromagnetic actuator such as a motor to drive opening and closing of the valve. However, the increased scale of the apparatus results from the use of a mechanism that utilizes the above electromagnetic actuator to control the open and close displacement or open and close time of the valve or the like as described above. Such a mechanism is thus unsuitable for portable fuel cells that need to constitute a small-sized system. Further, the mechanical movable part of the apparatus is also disadvantageous in terms of the lifetime of the apparatus.

On the other hand, a known apparatus has a micro-channel through which a fluid that can thermally reversibly change between a solid phase and a liquid phase flows as disclosed in Jpn. Pat. Appln. KOKAI No. 2002-215241. This apparatus adjusts the flow rate of the fluid by opening or closing the micro-channel; the channel is closed after the fluid has been brought into a solid state by cooling it to a phase transition point or lower, and is opened after the fluid has been brought into a liquid state by heating it to the phase transition point or higher.

However, the apparatus disclosed in Jpn. Pat. Appln. KOKAI No. 2002-215241 is disadvantageously limited to a fluid that can be changed from the liquid phase to the solid phase. Further, the apparatus requires large-scale cooling means for cooling the fluid to the phase transition point or lower. The apparatus is thus inapplicable to the adjustment of flow rate of a fuel to the fuel cell or fuel reformer, the size of which is desired to be reduced.

### BRIEF SUMMARY OF THE INVENTION

According to an aspect of the present invention, there is provided a system for adjusting a flow rate of a fluid, comprising:

a fluid supply source which supplies the fluid;

an orifice channel having a first flow resistance, configured to restrict a flow of the fluid;

a connection path having a second flow resistance, configured to connect the fluid supply source to the orifice channel, the first flow resistance being larger than the second flow resistance; and

a device configured to heat or cool at least part of the orifice channel to adjust a temperature of the fluid passing through the orifice channel.

According to another aspect of the present invention, there is provided a fuel cell system comprising:

a fluid supply source configured to supply a pressurized fluid;

an orifice channel having a first flow resistance, configured to restrict a flow of the fluid;

a connection path having a second flow resistance, configured to connect the fluid supply source to the orifice channel, the first flow resistance being larger than the second flow resistance;

a device configured to heat or cool at least part of the orifice channel to adjust a temperature of the fluid passing through the orifice channel;

a reformer, connected to the orifice channel, configured to reform the fluid into a gas containing hydrogen; and

a fuel cell, connected to the reformer, configured to generate power using the hydrogen.

According to another aspect of the present invention, there is provided a method of adjusting a flow rate of a fluid, comprising:

supplying and guiding the fluid with a supplying flow resistance;

restricting a flow of the fluid with a restricted flow resistance which is larger than the supplying flow resistance; and

heating or cooling at least part of the restricted fluid flow to adjust a temperature of the fluid flow.

### BRIEF DESCRIPTION OF THE SEVERAL VIEWS OF THE DRAWING

FIG. 1 is a block diagram schematically showing a fuel cell power generating apparatus to which a flow rate adjusting system according to a first embodiment;

FIG. 2 is an exploded perspective view schematically showing an orifice channel chip shown in FIG. 1;

FIG. 3 is a block diagram schematically showing another orifice channel chip shown in FIG. 1;

FIG. 4 is a graph showing an example of dependence of liquid viscosity coefficient on temperature, the graph illustrating the first embodiment;

FIG. 5 is a graph showing an example of dependence of gas viscosity coefficient on temperature, the graph illustrating the first embodiment;

FIG. 6 is a graph showing a variation in flow rate resulting from the control of temperature of an orifice channel in the orifice channel chip shown in FIG. 1;

FIG. 7 is a diagram showing a meniscus structure formed in the orifice channel in the orifice channel chip shown in FIG. 1;

FIG. 8 is a diagram showing a plurality of meniscus structures formed in the orifice channel in the orifice channel chip shown in FIG. 1;

FIG. 9 is a graph showing the dependence of saturated vapor pressure of dimethylether on temperature, the graph illustrating the first embodiment;

FIGS. 10A and 10B are tables showing a database used for a flow rate adjusting system according to a second embodiment;

FIG. 11 is a table showing a database used for a flow rate adjusting system according to a third embodiment;

FIG. 12 is a table showing a database used for a flow rate adjusting system according to a fourth embodiment;

FIGS. 13A to 13D are schematic diagrams showing an inflow connection portion to an orifice channel used in a flow rate adjusting system according to fifth and sixth embodiments;

FIGS. 14A and 14B are schematic diagrams showing an inflow connection portion to an orifice channel and a parallel orifice channel which are used in a flow rate adjusting system according to a seventh embodiment;

FIG. 15 is an exploded perspective view schematically showing an orifice channel chip used in a flow rate adjusting system according to an eighth embodiment;

FIGS. 16A to 16D are graphs illustrating an example of a temperature distribution in an orifice channel used in the eighth embodiment;

FIGS. 17A and 17B are timing charts illustrating an energization time and an energization cycle for a thin film micro-heater used in a flow rate adjusting system according to a ninth embodiment; and

FIG. 18 is a block diagram schematically showing a fuel cell power generating apparatus to which a flow rate adjusting system according to a tenth embodiment.

### DETAILED DESCRIPTION OF THE INVENTION

With reference to the drawings, description will be given of a flow rate adjusting system and a fuel cell system according to embodiments of the invention.

### First Embodiment

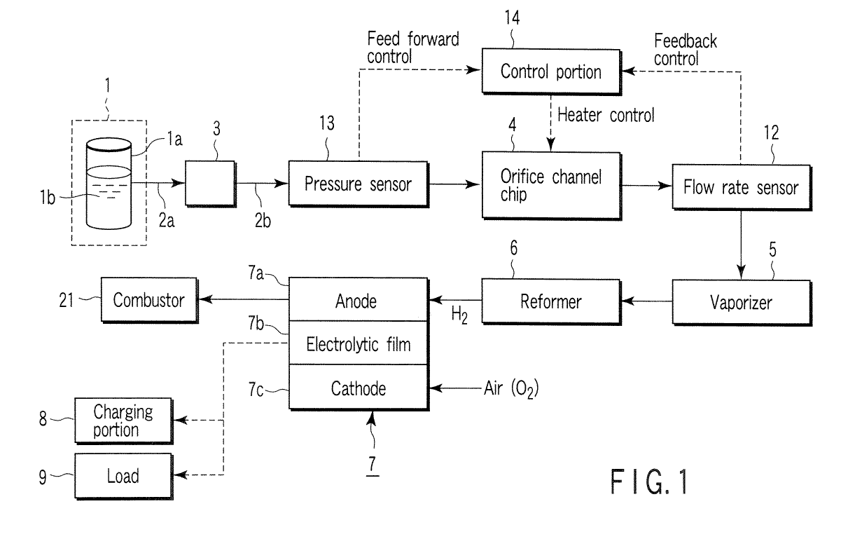

FIG. 1 is a block diagram schematically showing a fuel cell power generating apparatus to which a flow rate adjusting system according to a first embodiment.

In FIG. 1, reference numeral 1 denotes a fuel supply portion serving as a fuel supply source that supplies a fuel 1b. The fuel supply portion 1 comprises a fuel container 1a in which the pressurized fuel 1b is sealed. The fuel container 1a is made of a resin or metal material. The fuel 1b is pressurized and contains a liquefied gas (for example, dimethylether).

A stop valve 3 is connected to the fuel container 1a via a line 2a. The fuel 1b from the fuel container 1a is supplied to the stop valve 3, which is thus opened or closed to selectively supply the fuel 1b or stop the supply.

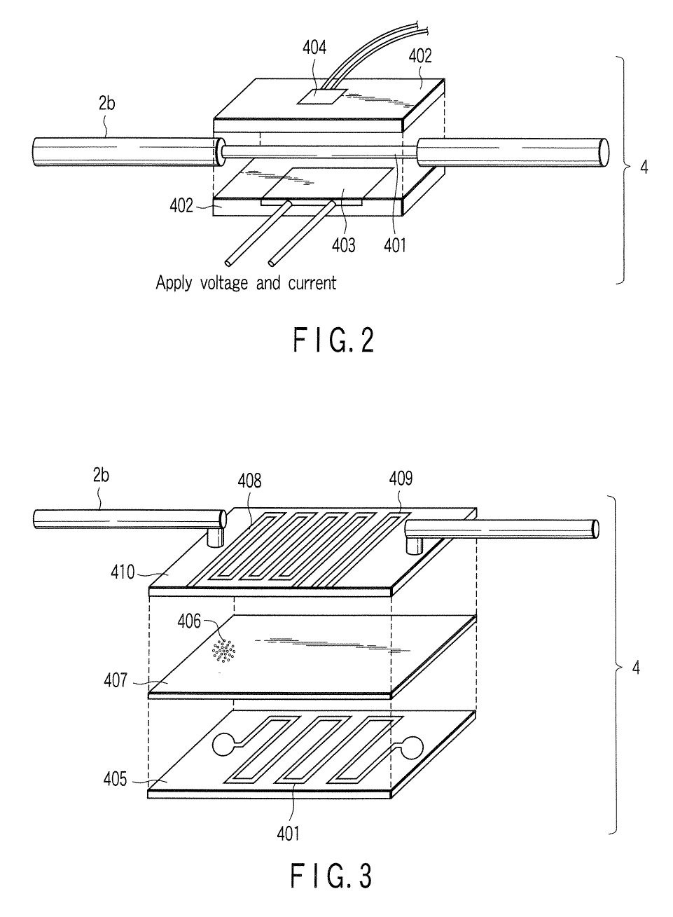

An orifice channel chip 4 is connected to the stop valve 3 via a line 2b. Opening the stop valve 3 allows the fuel 1b to be supplied to the orifice channel chip 4, which then adjusts the flow rate of the fuel 1b and outputs the fuel 1b of the adjusted flow rate. The orifice channel chip 4 will be described below in detail with reference to FIG. 2 or 3.

A reformer 6 and a fuel cell 7 are connected to the orifice chip 4 via a vaporizer 5. The fuel 1b from the orifice channel chip 4 is vaporized by the vaporizer 5. The vaporized fuel 1b is then supplied to the reformer 6, which then reforms the vaporized fuel 1b into a gas containing hydrogen. The gas is then supplied to the fuel cell 7, which has an electrolytic film 7b placed between an anode 7a and a cathode 7b. Each of the anode 7a and cathode 7b is composed of a current collector that collects charges and a catalyst layer. A hydrogen gas from the reformer 6 is supplied to the anode 7a to cause catalytic reaction to generate protons. On the other hand, air (O²) is supplied to the cathode 7c, in which the protons having passed through the electrolytic film 7b react, on the catalyst, with the oxygen contained in the air to generate power.

A charging portion 8 and a load 9 are connected to the fuel cell 7. The charging portion 8 consists of a secondary battery and is charged with power output by the fuel cell 7. The charging portion 8 outputs auxiliary power that compensates for the deficiency of power output by the fuel cell 7. The load 9 corresponds to an electronic circuit in a portable electronic instrument and is supplied with power directly by the fuel cell 7 or through the charging portion 8. A combustor 21 is connected to the fuel cell 7. The combustor 21 burns unreacted hydrogen using oxygen.

FIG. 2 schematically shows the structure of the orifice channel chip 4 shown in FIG. 1. In the orifice channel chip 4 shown in FIG. 2, a line for a channel with a large flow resistance, that is, an orifice channel 401, extends between cover plates 402 of material with a high thermal conductivity, for example, aluminum. The flow resistance of the orifice channel is larger than the flow resistance of the lines 2a, 2b. Thus, the flow rate of the fluid is more restricted in the orifice channel, rather than the fluid flow in the lines 2a, 2b. A temperature control module or unit 403 such as a ceramic heater or Peltier element is placed inside the cover plates 402 to control the temperature of the orifice channel 401. A temperature sensor 404 such as a thermocouple or a thermistor is placed outside the cover plates 402. The line of the orifice channel 401 is desirably made of a material having a high thermal conductivity and resisting corrosion. However, the line may be made of a material such as metal, glass, or resin.

FIG. 3 schematically shows the structure of another orifice channel chip 4. An orifice channel plate 405, a filter plate 407, and a cover plate 410 are stacked in the orifice channel chip 4 shown in FIG. 3. The orifice channel 401 is formed in the orifice channel plate 405 by etching or machining. A filter 406 is formed in the filter plate 407 by etching or machining; the filter 406 has a large number of holes (FIG. 3 shows only some of them) each of which is smaller than the inner diameter of the orifice channel 401. A thin film micro-heater 408 and a thin film temperature micro-sensor 409 are patterned and formed on the cover plate 410; the thin film micro-heater 408 controls the temperature of the orifice channel 401 and the thin film temperature micro-sensor 409 detects the temperature of the orifice channel 401.

The orifice channel chip 4 controls the energization of the temperature control module 403 or thin film micro-heater 408 to control the temperature of a part or the entire orifice channel 401. In other words, the temperature, in the orifice channel 401, of the fuel 1b flowing into the orifice channel 401 is controlled to a predetermined value.

It is assumed that the fuel 1b flowing into the orifice channel chip 4 has a single phase and is characterized to keep its phase unchanged within the controlled temperature range and pressure drop range of the orifice channel chip 4. Then, when the volume flow rate of the fuel 1b passing through the orifice channel 401 is Q [m³/s], the difference in pressure (pressure loss) between the inlet and outlet of the orifice channel 401 is ΔP[Pa] and the channel resistance of the orifice channel 401 is R[N·s/m⁵], the volume flow rate Q of the fuel 1b passing through the orifice channel 401 is determined by:
Q=ΔP/R (1)

If the channel has a circular cross section, the channel resistance R of the orifice channel 401 is determined by:
Rc=(128μ·l)/Πd⁴ (2)
where Rc denotes the channel resistance of the orifice channel with a circular cross section, μ denotes the viscosity coefficient of the fluid, l denotes the length of the orifice channel, and d denotes the diameter of the orifice channel.

If the channel has a rectangular cross section, the channel resistance R is determined by:

$${R}_{r} = \frac{64 μ l}{{a}^{3} b} {( \frac{16}{3} - \frac{1024}{{π}^{5}} \cdot \frac{a}{b} {\sum }_{n} \frac{1}{{n}^{5}} tanh \frac{n π b}{2 a} )}^{\text{-} 1} \qquad ( 3 )$$

where Rr denotes the channel resistance of the orifice channel with a rectangular cross section, a denotes the length of one side of the rectangular cross section, and b denotes the length of the other side of the rectangular cross section.

If the channel has a semicircular cross section, the channel resistance R is determined by:

$${R}_{hc} = \frac{128 {( π + 2 )}^{4} μ l}{{π}^{5} {d}^{4}} \qquad ( 4 )$$

where Rhc denotes the channel resistance of the orifice channel with a semicircular cross section, and d denotes the diameter of the orifice channel with the semicircular cross section.

Thus, the channel resistance R of the orifice channel 401 is determined by the different equations depending on the sectional shape of the orifice channel 401 as shown in Equations (2) to (4). However, the channel resistances R of these orifice channels 401 are the same in that they are in proportion to the viscosity coefficient μ of the fuel 1b.

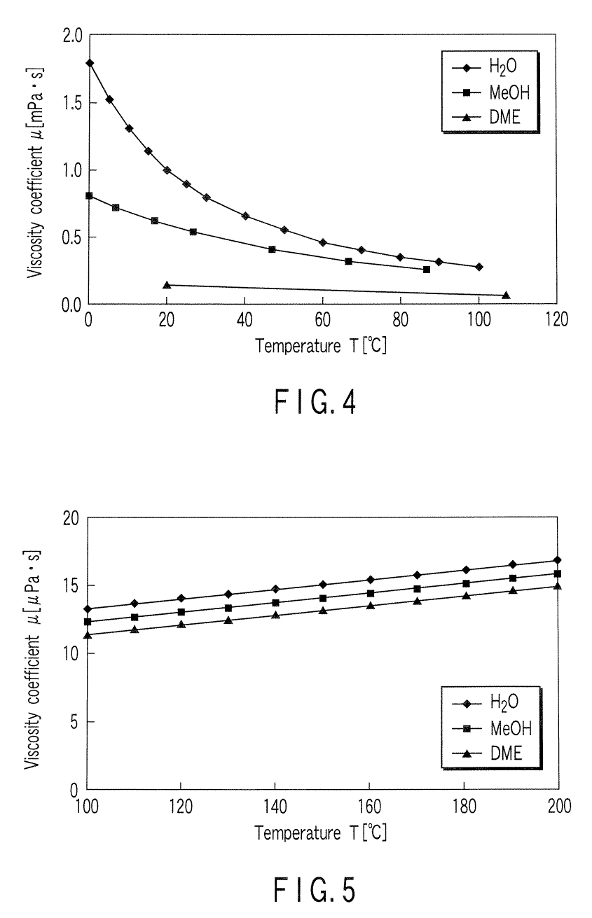

In general, the viscosity coefficient μ of the fluid varies with temperature T and thus exhibits temperature dependence. As an example of dependence of the fluid viscosity coefficient μ on the temperature, FIG. 4 shows variations in the viscosity coefficients of water (H₂O), methanol (MeOH), and dimethylether (DME) in a liquid phase depending on the temperature. FIG. 5 shows variations in the viscosity coefficients of water (H₂O), methanol (MeOH), and dimethylether (DME) in the gas phase depending on the temperature. These figures show that the viscosity coefficient μ decreases with increasing temperature T for the liquid but increases consistently with the temperature T for the gas.

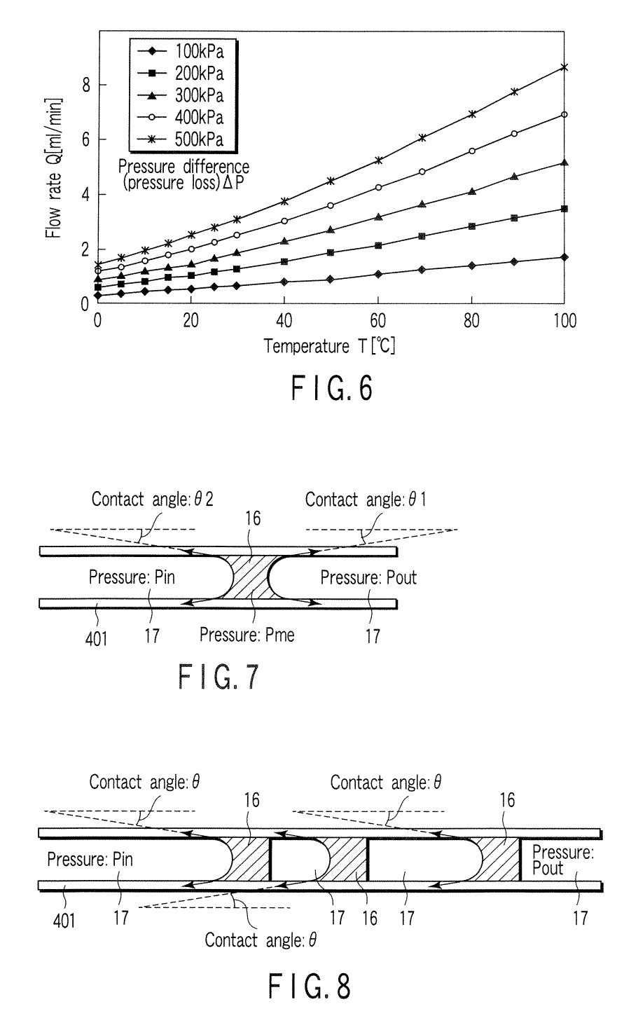

As shown in Equations (2) to (4), the channel resistance R of the orifice channel 401 is in proportion to the viscosity coefficient μ of the fluid. The channel resistance R of the orifice channel 401 can be varied by controlling the temperature of the orifice channel 401 to vary the temperature of the fuel 1b passing through the orifice channel 401. In other words, with the difference in pressure (pressure loss) between the inlet and outlet of the orifice channel 401 remaining unchanged, the volume flow rate Q can be varied in inverse proportion to the channel resistance R of the orifice channel 401. For example, with the orifice channel chip 4 composed of the orifice channel 40 with a circular cross section of inner diameter φ 100 μm and length 30 mm, varying the temperature T can vary the volume flow rate Q of water (liquid) as shown in FIG. 6 (calculations). FIG. 6 shows the results of variation, between 100 and 500 kPa, of the difference in pressure (pressure loss) AP between the inlet and outlet of the orifice channel 401.

These results apply not only to a single material but also to a mixed solution. That is, the volume flow rate Q can be varied on the basis of the viscosity coefficient μ of the mixed solution on the temperature.

It is then assumed that the fuel 1b flowing from the fuel supply source into the orifice channel chip 4 is a two-phase flow of a gas phase 17 and a liquid phase 16 and keeps its phases unchanged within the controlled temperature range and pressure drop range of the orifice channel chip 4. Then, in the orifice channel 401, a meniscus is formed at the phase boundary between the gas phase 17 and the liquid phase 16 as shown in FIG. 7.

A pressure drop ΔPm occurs in front of and behind the meniscus at the phase boundary between the gas phase 17 and the liquid phase 16, formed in the orifice channel 401. ΔPm is expressed by:
ΔPm=2γ (cos θ2−cos θ1)/r (5)
where ΔPm denotes the difference in pressure caused by the meniscus, r denotes the radius of the orifice channel with the circular cross section, γ denotes the surface tension of the fluid, θ₁ denotes the contact angle on the outlet side, and θ₂ denotes the contact angle on the inlet side.

It is assumed that the contact angle θ₁ on the outlet side is 90° and n meniscuses are formed in the orifice channel 401, as shown in FIG. 8. The pressure drop ΔPm0 caused by the meniscuses in the orifice channel 401 is expressed by:

Pm0=(2nγ cos θ)/r (6)

where θ denotes the contact angle on the inlet side.

As is understandable from Equation (6), the pressure drop ΔPm0 caused by the meniscuses is in proportion to the number of meniscuses and the surface tension of the liquid fuel and in inverse proportion to the radius r of the orifice channel 401. The orifice channel 401 has a reduced channel diameter d so as to increase the channel resistance and is thus significantly affected by a pressure drop caused by the meniscuses. Further, in general, the surface tension y of the liquid decreases with increasing fluid temperature T and becomes zero at a critical temperature Tc. As shown in Equation (6), the pressure drop ΔPm0 caused by the meniscuses in the orifice channel 401 is in proportion to the surface tension γ of the fluid. Accordingly, the controlling the temperature of the orifice channel 401 varies the temperature of the fuel 1b passing through the orifice channel 401. This makes it possible to vary the pressure drop ΔPm0 caused by the meniscuses. On the basis of a combination of this variation and the above variation of the channel resistance R based on the dependence of viscosity coefficient μ of the fluid on the temperature, the volume flow rate Q can be varied as shown in:
Q=(ΔP−ΔPm0)/R (7)

The channel resistance R of the orifice channel 401 is calculated taking the ratio of the gas phase 17 to the liquid phase 16 (void ratio) into account.

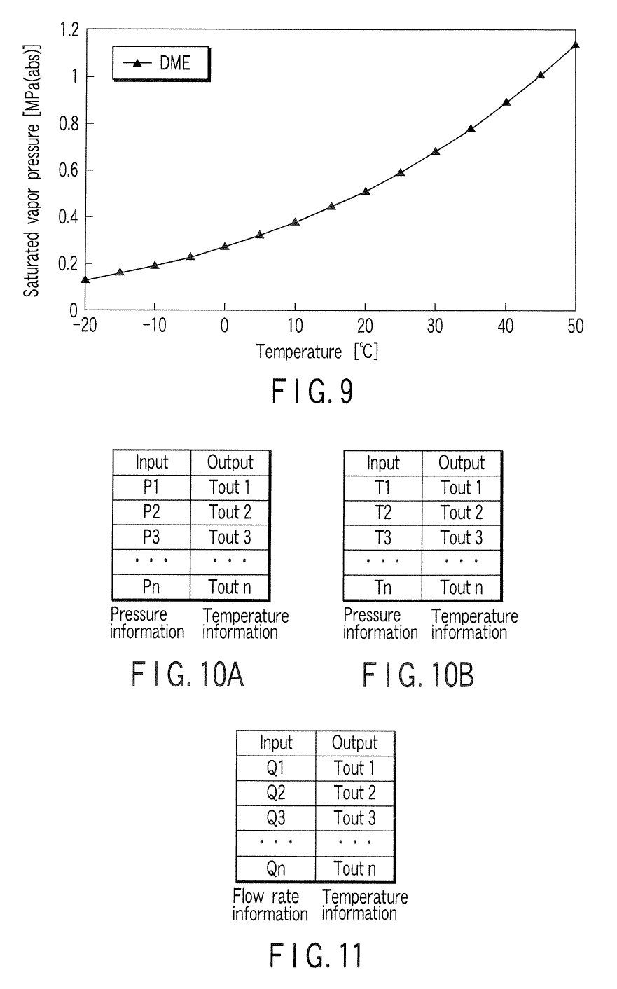

If a phase change occurs within the controlled temperature range and pressure drop range of the orifice channel chip 4, not only the above effects are exerted but also the phase change varies the channel resistance R and pressure. As shown in FIGS. 4 and 5, the viscosity coefficient μ of the fluid differs markedly between the liquid phase 16 and the gas phase 17. The channel resistance R and volume flow rate Q thus vary between the liquid phase 16 and the gas phase 17. However, since the liquid phase 16 and gas phase 17 have significantly different densities, a variation in density needs to be taken into account for the mass flow rate Qm. The phase change also varies the pressure. FIG. 9 shows that the saturated vapor pressure of dimethylether (DME) varies with the temperature. On the basis of a combination of these variations, the volume flow rate Q (mass flow rate Qm) can be varied.

As described above, this system supplies the fuel 1b pressurized in the fuel container 1a of the fuel supply portion 1, to the reformer 6 and fuel cell 7 through the orifice channel 401 in the orifice channel chip 4, which offers a large flow resistance. The temperature control module 403 or thin film micro-heater 408, provided in proximity to the orifice channel 401, controls the temperature of a part or all of the orifice channel 401. This makes it possible to vary the viscosity coefficient of the fuel 1b in the orifice channel 401, the surface tension, the void ration of the liquid phase to the gas phase, the number of meniscuses formed at the phase boundary, the pressure, and the like. This eliminates the need to provide the system with a mechanical movable portion to allow the size of the system to be reduced. The system can also adjust the flow rate of the fuel 1b having passed through the orifice channel 401 and stably control the flow rate of the fuel supplied to the reformer 6 and fuel cell 7.

### Second Embodiment

Now, description will be given of a flow rate adjusting system and a fuel cell system according to a second embodiment.

Blocks similar to those in FIG. 1, described in the first embodiment, constitute a fuel cell power generating apparatus to which the flow rate adjusting system according to the second embodiment is applied. Accordingly, FIG. 1 will be referred to again, and only components different from those in FIG. 1 will be described below.

As shown in FIG. 1, the flow rate adjusting system according to the second embodiment has a pressure sensor 13 placed upstream of the orifice channel chip 4. The pressure sensor 13 detects the pressure of the fuel 1b on the upstream side of the orifice channel chip 4.

A control module or unit 14 is connected to the pressure sensor 13. On the basis of a pressure detection signal output by the pressure sensor 13, the control module 14 outputs temperature information on the basis of which the orifice channel 401 is heated or cooled. The control module 14 thus controls the energization of the temperature control module 403 such as a ceramic heater or a Peltier element which serves as a heater, or the thin film micro-heater 408. That is to say, the pressure detection signal from the pressure sensor 13 allows what is called feed-forward control to be performed to control the temperature of the heater.

In this system, the control module 14 is provided with a database that stores temperature information Tout1, Tout2, . . . corresponding to pressure information P1, P2, . . . input by the pressure sensor 13 as pressure detection signals as shown in FIG. 10A. The pressure information from the pressure sensor 13 is input to the control module 14, which then outputs the temperature information corresponding to the pressure information. The relationship between the pressure information P1, P2, . . . and the temperature information Tout1, Tout2, . . . is based on the relationship described in the first embodiment. Data experimentally obtained is used to determine the relationship. Of course, the control module 14 may have a conversion function for converting the pressure information from the pressure sensor 13 into predetermined temperature information on the basis of a function f(x) and then outputting the temperature information.

As described above, what is called feed forward control is performed. Specifically, on the basis of the database or function, the pressure information from the pressure sensor 13 is converted into information on the basis of which the orifice channel 401 is heated or cooled, to control the energization of the temperature control module 403 or thin film micro-heater 408. Consequently, with the adverse effect of disturbances eliminated, the volume flow rate Q (mass flow rate Qm) of the fuel 1b flowing through the orifice channel 401 can be stably maintained or varied.

Instead of the pressure sensor 13, the temperature sensor may be placed upstream of the orifice channel chip 4. Feed forward control may be performed such that on the basis of the temperature information from a temperature sensor, the control module 14 outputs temperature information on the basis of which the orifice channel 401 is heated or cooled, to control the energization of the temperature control module 403 such as a ceramic heater or Peltier element, or the thin film micro-heater 408. Also in this system, the control module 14 is provided with a database that stores the temperature information Tout1, Tout2, . . . corresponding to temperature information T1, T2, . . . input by the temperature sensor as shown in FIG. 10B. The temperature information from the temperature sensor is input to the control module 14, which then outputs the temperature information corresponding to this temperature information. The control module 14 may convert the temperature information from the temperature sensor into predetermined temperature information on the basis of the function f(x) and then output the predetermined temperature information.

The control sensor 13 or temperature sensor can exert similar effects even when placed downstream of the orifice channel chip 4.

### Third Embodiment

Now, description will be given of a flow rate adjusting system and a fuel cell power generating apparatus according to a third embodiment.

Blocks similar to those in FIG. 1, described in the first embodiment, constitute the fuel cell power generating apparatus to which the flow rate adjusting system according to the third embodiment is applied. Accordingly, FIG. 1 will be referred to again, and only components different from those in FIG. 1 will be described below.

The system shown in FIG. 1 has a flow rate sensor 12 placed downstream of the orifice channel chip 4. The flow rate sensor 12 detects the flow rate of the fuel 1b on the downstream side of the orifice channel chip 4.

The control module 14 is connected to the flow rate sensor 12. The control module 14 performs what is called feedback control. Specifically, on the basis of flow rate information output by the flow rate sensor 12, the control module 14 outputs temperature information on the basis of which the orifice channel 401 is heated or cooled, to control the energization of the temperature control module 403 such as a ceramic heater or a Peltier element, or the thin film micro-heater 408.

In this system, the control module 14 is provided with a database that stores the temperature information Tout1, Tout2, . . . corresponding to flow rate information Q1, Q2, . . . input by the flow rate sensor 12 as shown in FIG. 11. The flow rate information from the flow rate sensor 12 is input to the control module 14, which then outputs the temperature information corresponding to the flow rate information. The relationship between the flow rate information Q1, Q2, . . . and the temperature information Tout1, Tout2, . . . is based on the relationship described in the first embodiment. Data experimentally obtained is used to determine the relationship. Of course, the control module 14 may convert the flow rate information from the flow rate sensor 12 into predetermined temperature information on the basis of the function f(x) and then output the temperature information.

Therefore, what is called feedback control is performed in the system having the flow rate sensor 12 provided downstream of the orifice circuit 401 to sense the flow rate. Specifically, on the basis of the database or function, the flow rate information from the flow rate sensor 12 is converted into information on the basis of which the orifice channel 401 is heated or cooled, to control the energization of the temperature control module 403 or thin film micro-heater 408. Consequently, while eliminating the adverse effect of disturbances, this system can stably maintain or vary the volume flow rate Q (mass flow rate Qm) in the orifice channel 401.

The flow rate sensor 12 can exert similar effects even when placed upstream of the orifice channel chip 4.

### Fourth Embodiment

Now, description will be given of a flow rate adjusting system and a fuel cell power generating apparatus according to a fourth embodiment.

Blocks similar to those in FIG. 1, described in the first embodiment, constitute the fuel cell power generating apparatus to which the flow rate adjusting system according to the fourth embodiment is applied. Accordingly, FIG. 1 will be referred to again, and only components different from those in FIG. 1 will be described below.

As shown in FIG. 1, the pressure sensor 13 is placed upstream of the orifice channel chip 4. The flow rate sensor 12 is placed downstream of the orifice channel chip 4. The pressure sensor 13 detects the pressure of the fuel 1b on the upstream side of the orifice channel chip 4. The flow rate sensor 12 detects the flow rate of the fuel 1b on the downstream side of the orifice channel chip 4.

The control module 14 is connected to the pressure sensor 13 and flow rate sensor 12. On the basis of the information output by the pressure sensor 13 and flow rate sensor 12, the control module 14 outputs temperature information on the basis of which the orifice channel 401 is heated or cooled, to control the energization of the temperature control module 403 such as a ceramic heater or a Peltier element, or the thin film micro-heater 408.

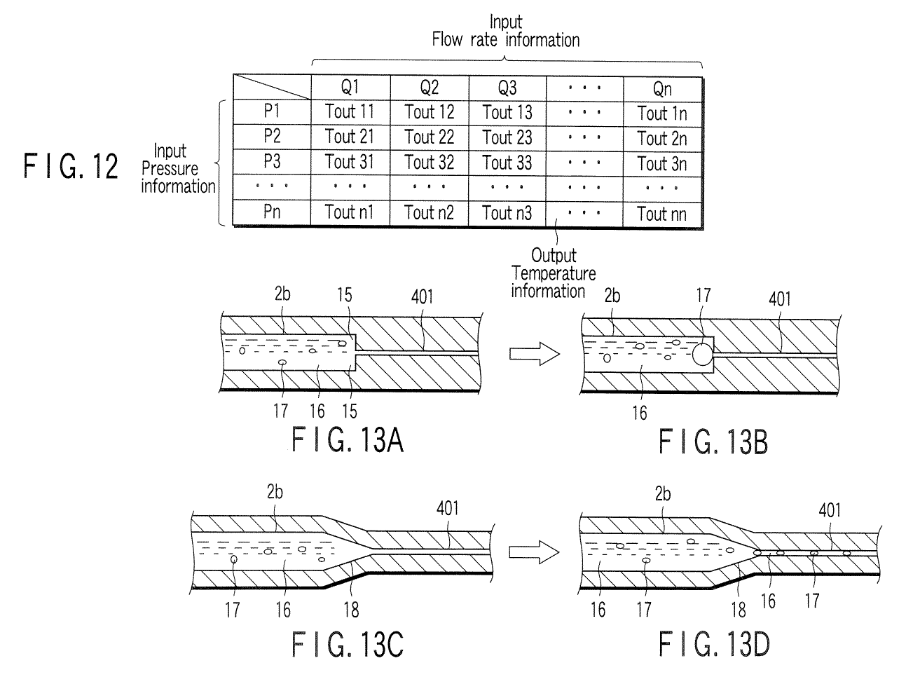

In this system, the control module 14 is provided with a database that stores the temperature information Tout1, Tout2, . . . corresponding to the pressure information input by the pressures sensor 13 and the flow rate information Q1, Q2, . . . input by the flow rate sensor 12 as shown in FIG. 12. The pressure information from the pressure sensor 13 and the flow rate information from the flow rate sensor 12 are input to the control module 14, which then outputs the temperature information corresponding to the pressure and flow rate information. The relationship between both pressure information P1, P2, . . . and flow rate information Q1, Q2, . . . and the temperature information Tout1, Tout2, . . . is based on the relationship described in the first embodiment. Data experimentally obtained is used to determine the relationship. The control module 14 may convert the pressure and flow rate information from the pressure sensor 13 and flow rate sensor 12, respectively, into predetermined temperature information on the basis of a function f(x, y) and then output the temperature information.

Therefore, the following control is performed in the system having the pressure sensor 13 provided upstream of the orifice circuit 401 to sense the pressure and the flow rate sensor 12 provided downstream of the orifice circuit 401 to sense the flow rate. On the basis of the database or function, the information from the pressure sensor 13 and flow rate sensor 12 is converted into information on the basis of which the orifice channel 401 is heated or cooled, to control the energization of the temperature control module 403 or thin film micro-heater 408. Consequently, while eliminating the adverse effect of disturbances, this system can also stably maintain or vary the volume flow rate Q (mass flow rate Qm) in the orifice channel 401.

Also in this case, instead of the pressure sensor 13, the temperature sensor may be placed upstream of the orifice channel chip 4. Further, the pressure sensor 13 and flow rate sensor 12 can exert similar effects even when placed downstream and upstream, respectively, of the orifice channel chip 4.

### Fifth Embodiment

Now, description will be given of a flow rate adjusting system and a fuel cell power generating apparatus according to a fifth embodiment.

Blocks similar to those in FIG. 1, described in the first embodiment, constitute the fuel cell power generating apparatus to which the flow rate adjusting system according to the fifth embodiment is applied. Accordingly, FIG. 1 will be referred to again, and only components different from those in FIG. 1 will be described below.

The orifice channel chip 4 comprises an inflow portion through which the fuel 1b flows to the orifice channel 401 as shown in FIG. 13A. In the inflow portion, when the orifice channel 401 with a small inner diameter is connected to the line 2b with a large inner diameter, the fuel 1b may reside in this connection portion to form a residing portion 15. As a result, bubbles (gas phase) 17 flowing from the upstream side remain in the residing portion 15, and merge with subsequent bubbles (gas phase) 17 to increase the volume. Finally, the bubbles 17 may grow to block the line 2b. As shown in FIG. 13B, the bubbles (gas phase) 17 flow into the orifice channel 401 significantly varies the volume flow rate Q of the fuel having passed through the orifice channel 401.

Thus, as shown in FIG. 13C, a tapered channel 18 is preferably formed in the inflow portion between the line 2b and the orifice channel 401 so that the fuel 1b flows from the line 2b with the large inner diameter into the orifice channel 401 via the tapered channel 18. The structure with the tapered channel 18 formed in the inflow portion to the orifice channel 401 can prevent such a residing portion 15 as shown in FIG. 13A from being formed in the inflow portion between the line 2b and the orifice channel 401. With the residing portion 15 unformed, the bubbles (gas phase) 17 flowing from the upstream side flow into the orifice channel 401, as they are without merging with the subsequent bubbles (gas phase) 17, as shown in FIG. 13D. This makes it possible to avoid varying the volume flow rate Q (mass flow rate [Qm]) of the fuel having passed through the orifice channel 401. The fuel supply flow rate can thus be stably controlled.

### Sixth Embodiment

Now, description will be given of a flow rate adjusting system and a fuel cell power generating apparatus according to a sixth embodiment.

In this system, the interior of the tapered channel 18 is subjected to a hydrophilic treatment, for example, a silica-based coating consisting mainly of water glass, a hydrophilic resin coating, or a titanium oxide coating; the tapered channel 18 is formed in the inflow portion between the line 2b and the orifice channel 401 as shown in FIGS. 13C and 13D, described in the fifth embodiment. The hydrophilic treatment may be executed not only on the interior of the tapered channel 18 but also on the interior of the orifice channel 401.

Since the hydrophilic treatment is executed on the interior of the orifice channel 401 and on the interior of inflow portion to the orifice channel, the bubbles (gas phase) 17 flowing in from the upstream side of the orifice channel 401 are prevented from adhering to the surface of the channel wall. The bubbles (gas phase) 17 adhering to the surface of the channel wall can also be easily removed. As a result, the bubbles (gas phase) 17 flowing from the upstream side flow into the orifice channel 401, as they are without merging with the subsequent bubbles (gas phase) 17. This makes it possible to avoid varying the volume flow rate Q (mass flow rate [Qm]) of the fuel having passed through the orifice channel 401. The fuel supply flow rate can thus be stably controlled.

### Seventh Embodiment

Now, description will be given of a flow rate adjusting system and a fuel cell power generating apparatus according to a seventh embodiment.

Blocks similar to those in FIG. 1, described in the first embodiment, constitute the fuel cell power generating apparatus to which the flow rate adjusting system according to the seventh embodiment is applied. Accordingly, FIG. 1 will be referred to again, and only components different from those in FIG. 1 will be described below.

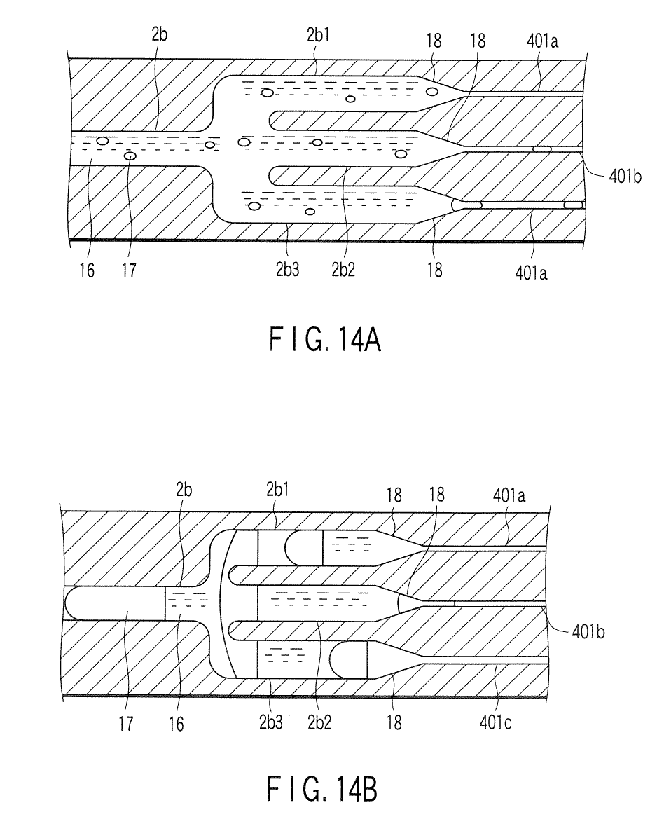

In the flow rate adjusting system according to the seventh embodiment, a plurality of (in the example shown in FIG. 4A, three) orifice channels 401a, 401b, and 401c are arranged in the orifice channel chip 4 in parallel as shown in FIG. 14A. The bubbles (gas phase) 17 flowing in from the upstream side are distributedly flow into the orifice channels 401a, 401b, and 401c. This enables a reduction in the adverse effect of the bubbles (gas phase) 17 flowing into one orifice channel 401a (401b or 401c). Further, the bubbles (gas phase) 17 can be allowed to flow into the orifice channels 401a, 401b, and 401c at different times by varying the flow resistances R of the orifice channels 401a and 401b and 401c or varying the lengths of the lines 2b1, 2b2, and 2b3 from the flow distribution to the inflow into the orifice channels 401a, 401b, and 401c.

Thus, this flow rate adjusting system has the plurality of orifice channels 401a, 401b, and 401c arranged in parallel to effectively distribute the bubbles (gas phase) 17. The flow rate adjusting system can therefore reduce the adverse effect of the bubbles (gas phase) 17. Further, by allowing the bubbles (gas phase) 17 to flow into the orifice channels 401a, 401b, and 401c at different times, it is possible to avoid varying the volume flow rate Q (mass flow rate [Qm]) of the fuel having passed through the orifice channels 401a, 401b, and 401c. The fuel supply flow rate can thus be stably controlled.

As shown in FIG. 14B, even if the bubble (gas phase) 17 large enough to block the line 2b and a liquid phase 16 alternately flow in from the upstream side, they are distributedly flow into the orifice channels 401a, 401b, and 401c. This enables a reduction in the adverse effect of the bubbles (gas phase) 17 flowing into one orifice channel 401a (401b or 401c). Further, the bubbles (gas phase) 17 can be allowed to flow into the orifice channels 401a, 401b, and 401c at different times by varying the flow resistances R of the orifice channels 401a and 401b and 401c and thus the lengths of the lines 2b1, 2b2, and 2b3 from the flow distribution to the inflow into the orifice channels 401a, 401b, and 401c. This makes it possible to avoid varying the volume flow rate Q (mass flow rate [Qm]) of the fuel having passed through the orifice channels 401a, 401b, and 401c. The fuel supply flow rate can thus be stably controlled.

For the flow rate adjusting system having the orifice circuits 401a, 401b, and 401c arranged in parallel, the total flow resistance of the orifice channels 401a, 401b, and 401c is calculated as in the case of an electric resistance. For example, for the three parallel orifice channels 401a, 401b, and 401c, the total flow resistance R is expressed by Equation (7) using the resistances R1, R2, and R3 of the orifice channels 401a, 401b, and 401c.
1/R=(1/R1)+(1/R2)+(1/R3)
R=(R1·R2·R3)/(R2·R3+R1·R3+R1·R2) (7)

### Eighth Embodiment

Now, description will be given of a flow rate adjusting system and a fuel cell power generating apparatus according to an eighth embodiment.

Blocks similar to those in FIG. 1, described in the first embodiment, constitute the fuel cell power generating apparatus to which the flow rate adjusting system according to the eighth embodiment is applied. Accordingly, FIG. 1 will be referred to again, and only components different from those in FIG. 1 will be described below.

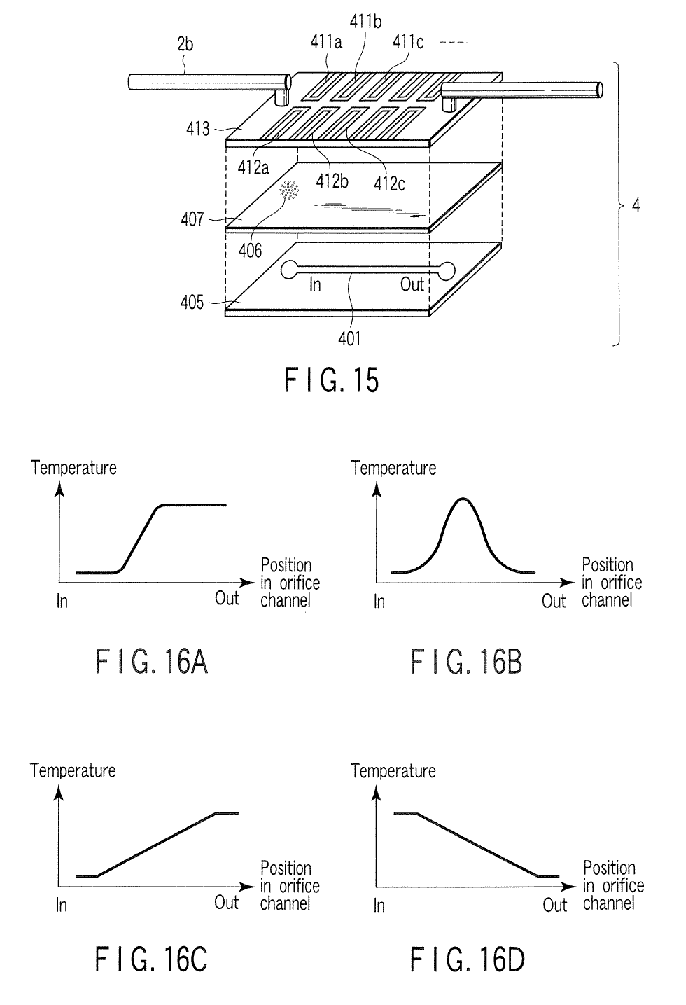

The flow rate adjusting system according to the eighth embodiment has the orifice channel plate 405, filter plate 407, and cover plate 410 stacked in the orifice channel chip 4 as shown in FIG. 15. The orifice channel 401 is formed in the orifice channel plate 405 by etching or machining. The filter 406 is formed in the filter plate 407 by etching or machining; the filter 406 has a large number of holes (FIG. 15 shows only some of them) each of which is smaller than the inner diameter of the orifice channel 401. A plurality of separate thin film micro-heaters 411a, 411b, 411c, . . . and a plurality of separate thin film temperature micro-sensors 412a, 412b, 412c, . . . are patterned on the cover plate 413.

The plurality of separate thin film micro-heaters 411a, 411b, 411c, . . . and plurality of separate thin film temperature micro-sensors 412a, 412b, 412c, . . . are arranged along the longitudinal direction of the orifice channel 401. Selective control of energization of the thin film micro-heaters 411a, 411b, 411c, . . . enables the orifice channel 401 to be provided with an arbitrary temperature distribution.

This system heats or cools the fuel 1b flowing from the line 2b into the orifice channel 401 in accordance with the temperature distribution formed in the orifice channel 401. For example, any of various temperature distributions may be created in the orifice channel 401 as shown in FIGS. 16A to 16D. In other words, the temperature of the orifice channel 401 is controlled so that the orifice channel 401 has a certain temperature distribution. This makes it possible to arbitrarily specify a position in the orifice channel 401 where the phase of the fuel 1b changes. As a result, the volume flow rate Q (mass flow rate Qm) can be stably maintained or varied.

### Ninth Embodiment

Now, description will be given of a flow rate adjusting system and a fuel cell power generating apparatus according to a ninth embodiment.

Blocks similar to those in FIG. 1, described in the first embodiment, constitute the fuel cell power generating apparatus to which the flow rate adjusting system according to the ninth embodiment is applied. Accordingly, FIG. 1 will be referred to again, and only components different from those in FIG. 1 will be described below.

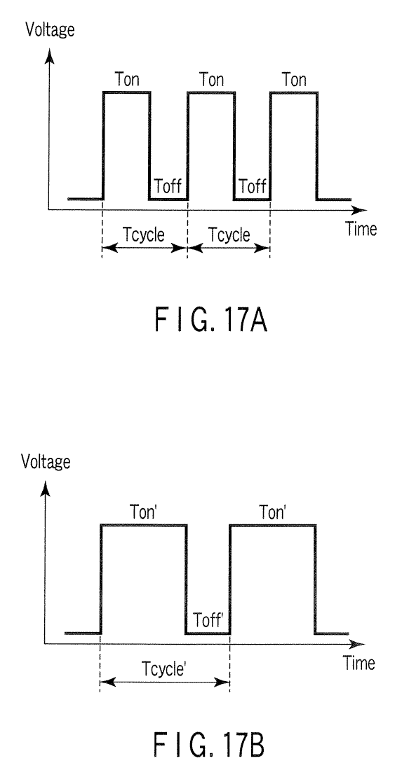

In this system, the orifice control chip 4 has the plurality of separate thin film micro-heaters 411a, 411b, 411c, . . . and the plurality of separate thin film temperature micro-sensors 412a, 412b, 412c, . . . as described in the eighth embodiment. Further, at least one of the thin film micro-heaters 412a, 412b, 412c, . . . is subjected to intermittent energization control. Specifically, an energization and non-energization times Ton and Toff or the time period of an energization cycle Tcycle is changed to time periods Ton′ and Toff′ as shown in FIGS. 17A and 17B. Moreover, the time period of an energization cycle Tcycle′ is controllably varied. In other words, the duty of energization and non-energization or the period of energization is controllably varied.

The system intermittently controlling the energization of the thin film micro-heaters 411a, 411b, 411c, . . . generate bubbles (gas phase) 17 in the fuel 1b in the orifice channel 401 to raise the pressure of the fuel to control its flow rate. In this system, the interior of the orifice channel 401 may be subjected to a hydrophilic treatment, for example, a silica-based coating consisting mainly of water glass, a hydrophilic resin coating, or a titanium oxide coating to enable the bubbles (gas phase) 17 generated to be smoothly removed. Here, the hydrophilicity refers to a contact angle of at most 90° at which the channel contacts the fluid. Conditions for the measurement of the contact angle include a target fluid and the range of temperature within which the flow rate adjusting system may be used.

This system can vary the energization time Ton or the time period of the energization cycle Tcycle for the thin film micro-heaters 411a, 411b, 411c, . . . , and thus the volume flow rate Q (mass flow rate Qm). Furthermore, the thin film micro-heaters 411a, 411b, 411c, . . . are intermittently energized, thus enabling a reduction in power consumption and a burden on the fuel cell 7, the power source.

### Tenth Embodiment

Now, description will be given of a flow rate 5 adjusting system and a fuel cell power generating apparatus according to a tenth embodiment.

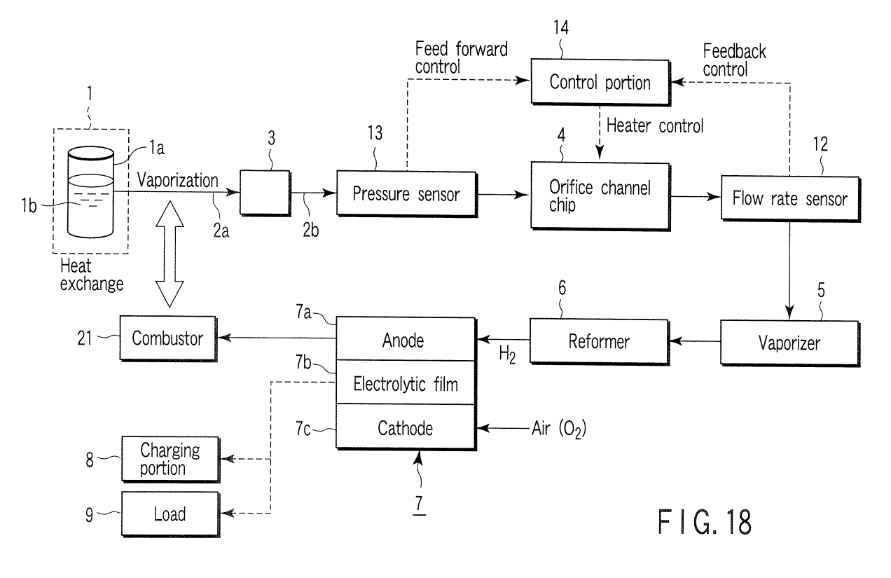

FIG. 18 schematically shows the fuel cell power generating apparatus to which the flow rate adjusting system according to the tenth embodiment is applied. In this figure, the same components as those in FIG. 1 are denoted by the same reference numerals.

This apparatus has a combustor 21 connected to the fuel cell 7. In the fuel cell 7, hydrogen and oxygen react with each other to generate water. However, gas discharged by the fuel cell 7 may contain unreacted hydrogen. The combustor 21 burns the unreacted hydrogen via oxygen and exchanges heat resulting from the combustion to vaporize the fuel 1b from the fuel container 1a. The vaporized fuel 1b is supplied to the orifice channel 401 in the orifice channel chip 4.

This apparatus converts the fuel 1b flowing from the fluid supply source into the orifice channel 401, into a gas phase before supplying it to the orifice channel chip 4. This enables the flow rate of the fuel 1b in the orifice channel 401 to be stably controlled.

Of course, instead of the combustor 21, an independent heater may be provided to heat and vaporize the fuel 1b from the fuel container 1a, with the vaporized fuel 1b supplied to the orifice channel 401 in the orifice channel chip 4.

In the description of the above embodiments, the flow rate adjusting system adjusts the flow rate of the fuel supplied to the fuel cell or fuel reformer. However, the application of the system is not limited to the fuel cell or fuel reformer and the present invention is applicable to any flow rate adjusting system that controls the flow rate of a fuel supplied. Further, the above embodiments have been described in conjunction with the liquefied gas fuel. However, the present invention is applicable to any fluid other than the liquefied gas.

The flow rate adjusting system and fuel cell power generating apparatus according to the embodiments include the following aspects.

(1) The temperature control means for controlling the temperature of the orifice channel is able to perform control such the orifice channel has a temperature distribution so as to specify a position where a phase change occurs.

(2) The temperature control means for controlling the temperature of the orifice channel has a heater or a Peltier element and intermittently controllably energizes the heater or Peltier element to vary the time period or interval of energization.

As described above, the present invention can provide a small-sized flow rate adjusting system and a small-sized fuel cell system which can stably adjust flow rate without the need for any mechanical movable part.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system for adjusting a flow rate of a fluid, comprising:
a fluid supply source which supplies the fluid;
an orifice channel having a first flow resistance, configured to restrict a flow of the fluid;
a connection path having a second flow resistance, configured to connect the fluid supply source to the orifice channel, the first flow resistance being larger than the second flow resistance; and
a device configured to heat or cool at least part of the orifice channel to adjust a temperature of the fluid passing through the orifice channel.

2. The system according to claim 1, further comprising a sensor provided on an upstream side or a downstream side of the orifice channel to detect one of the pressure, temperature, and flow rate of the fluid and generate a detection signal, and a control unit configured to control the device on the basis of the detection signal.

3. The system according to claim 1, further comprising a tapered channel connected between the connection path and the orifice channel, configured to supply the fluid from the connection path to the orifice channel, smoothly.

4. The system according to claim 2, further comprising a tapered channel connected between the connection path and the orifice channel, to supply the fluid from the connection path to the orifice channel, smoothly.

5. The system according to claim 3, wherein the tapered channel having a inner surface subjected to a hydrophilic treatment.

6. The system according to claim 4, wherein the tapered channel having a inner surface subjected to a hydrophilic treatment.

7. The system according to claim 1, wherein the orifice channel includes a plurality of orifice channel segments which are arranged in parallel.

8. The system according to claim 2, wherein the orifice channel includes a plurality of orifice channel segments which are arranged in parallel.

9. A fuel cell system comprising:
a fluid supply source configured to supply a pressurized fluid;
an orifice channel having a first flow resistance, configured to restrict a flow of the fluid;
a connection path having a second flow resistance, configured to connect the fluid supply source to the orifice channel, the first flow resistance being larger than the second flow resistance;
a device configured to heat or cool at least part of the orifice channel to adjust a temperature of the fluid passing through the orifice channel;
a reformer, connected to the orifice channel, configured to reform the fluid into a gas containing hydrogen; and
a fuel cell, connected to the reformer, configured to generate power using the hydrogen.

10. The system according to claim 9, wherein the fuel contains a liquefied gas.

11. The system according to claim 9, further comprising a sensor provided on an upstream side or a downstream side of the orifice channel to detect one of the pressure, temperature, and flow rate of the fluid and generate a detection signal, and a control unit configured to control the device on the basis of the detection signal.

12. The system according to claim 9, further comprising a tapered channel connected between the connection path and the orifice channel, configured to supply the fluid from the connection path to the orifice channel, smoothly.

13. The system according to claim 12, wherein the tapered channel having a inner surface subjected to a hydrophilic treatment.

14. A method of adjusting a flow rate of a fluid, comprising:
supplying and guiding the fluid with a supplying flow resistance;
restricting a flow of the fluid with a restricted flow resistance which is larger than the supplying flow resistance; and
heating or cooling at least part of the restricted fluid flow to adjust a temperature of the fluid flow.

15. The method according to claim 14, further comprising sensing one of the pressure, temperature, and flow rate of the fluid at an upstream side or a downstream side of the fluid flow and generate a detection signal and controlling the heating or cooling of the fluid flow on the basis of the detection signal.

16. The method according to claim 14, wherein the restricting the fluid flow include dividing the fluid flow into fluid streams.
